(19) United States
(12) Patent Application Publication
(10) Pub. No.: US 2026/0110772 A1
(43) Pub. Date: Apr. 23, 2026

(54) SHORT RANGE RADAR DEVICE

(71) Applicant: KaiKuTek Inc., Taipei City (TW)

(72) Inventors: Mike Chun-Hung WANG, Taipei City (TW); Yi-Chu CHEN, Taipei City (TW); Hsiang-Chieh JHAN, Taipei City (TW); Yi-Ting TSENG, Taipei City (TW); Tsung-Ming TAI, Taichung City (TW)

(73) Assignee: KaiKuTek Inc., Taipei City (TW)

(21) Appl. No.: 18/923,391

(22) Filed: Oct. 22, 2024

(51) Int. Cl. G01S 7/35

(52) U.S. Cl. CPC G01S 7/352

(57) ABSTRACT

A short-range radar device comprises a receiving antenna, an input transformer connected to the receiving antenna, a tunable-local-oscillator amplifier to receive a radar signal, a local-oscillator transformer connected to the tunable-local-oscillator amplifier, a mixer respectively connected to the input transformer and the local-oscillator transformer, and an adjustable-transimpedance amplifier connected to the mixer and outputting an intermediate-frequency signal. Portion of a differential signal output by the local-oscillator transformer is leaked to the receiving antenna through the mixer and/or through signal coupling between the local-oscillator transformer and the input transformer, and the portion of the differential signal leaking to the receiving antenna can be used as the radar signal radiated by the short-range radar device of the present invention, so as to detect targets at near distances, and therefore a dedicated transmitting antenna and its related amplifier circuits can be optionally eliminated to achieve the objective of the present invention.

### BACKGROUND OF THE INVENTION

### 1. Field of the Invention

The present invention relates to a radar device, especially to a short-range radar device that can be used in short-range detection.

### 2. Description of the Related Art

As shown in FIG. 5, a conventional radar device 80 has a transmitting antenna 81 and a receiving antenna 84. The radar signal sent by a radar signal synthesizer 83 is divided into radar signals A and B which are output to a transmitting antenna 81 and a mixer 86, respectively. The radar signal A is amplified by an output power amplifier 82 and then radiated by the transmitting antenna 81 as a radar wave. The radar wave is reflected by a target 100 and received by the receiving antenna 84 as a reflected signal C which is amplified by a low-noise-receiving amplifier (LNA) 85 and then mixed with the radar signal B through the mixer 86 to generate an intermediate-frequency signal D. Subsequently, the intermediate-frequency signal D is converted into a digitized raw data E through an analog-to-digital converter (ADC) 87, and the digitized raw data E is processed by a digital signal processor (DSP) 88 to obtain a feature map, so that the relative distance and orientation information between the target 100 and the radar can be obtained based on the feature map.

As shown in FIG. 6, FIG. 6 illustrates a relationship between the frequency difference fb and the signal delay time td of the radar signal A and the reflected signal C for the radar device 80. FIG. 6 also illustrates an intermediate-frequency signal D output by the mixer after mixing the radar signal A and the reflected signal C, and a Fourier transform of the intermediate-frequency signal D waveform.

Since the radiated radar wave usually has a certain intensity, the radar device 80 can detect a target at a longer distance. However, when a target within a shorter range is to be detected, the radar device 80 does not need to emit radar wave of such an intensity. As a result, how to modify the conventional radar device 80 for suitably detecting targets within a shorter range is an issue worthy of exploring with certain market demands.

### SUMMARY OF THE INVENTION

In view of the aforementioned issues of the prior art, the present invention discloses a short-range radar device, comprising:
a receiving antenna with a signal end;
an input transformer having a primary side and a secondary side, one end of the primary side of the input transformer connected to the signal end of the receiving antenna, and another end of the primary side of the input transformer being a ground end;
a tunable-local-oscillator amplifier having a pair of input ends and a pair of output ends, the pair of input ends of the tunable-local-oscillator amplifier configured to receive a radar signal;
a local-oscillator transformer having a primary side and a secondary side, and both ends of the primary side of the local-oscillator transformer respectively connected to a pair of output ends of the tunable-local-oscillator amplifier;
a mixer having a first input end, a second input end, a first output end, a second output end, a first control end, and a second control end; the first input end and the second input end of the mixer respectively connected to both ends of the secondary side of the input transformer, and the first control end and the second control end of the mixer respectively connected to both ends of the secondary side of the local-oscillator transformer;
a transimpedance amplifier having a first input end, a second input end, a first output end, and a second output end; the first input end and the second input end of the transimpedance amplifier respectively connected to the mixer, the first output end and the second output end of the transimpedance amplifier configured to jointly output an intermediate-frequency signal.

The aforesaid technical features regarding the short-range radar device of the present invention mainly involves leakage of the differential signal output from the local-oscillator transformer to the receiving antenna through the mixer and/or through the signal coupling between the local-oscillator transformer and the input transformer. The portion of the differential signal output leaking from the local-oscillator transformer to the receiving antenna can serve as a radar signal radiated by the short-range radar device of the present invention, and can be used to detect targets at near distances. Further, the portion of the differential signal output leaking from the local-oscillator transformer to the receiving antenna can be controlled by tuning the output amplitude of the tunable-local-oscillator amplifier and/or by adjusting the magnitude of the input DC-bias Vos of the adjustable-transimpedance amplifier, and thereby the intensity of the radar signal radiated by the short-range radar device of the present invention can be controlled. As a result, the radar signal can be maintained in a controllable and stable state and thereby stable detection for targets at near distances can be achieved. Compared with conventional radar devices, the short-range radar device of the present invention is suitable for detecting targets at near distances without using a dedicated transmitting antenna and its related amplifier circuits, etc., so that the size, power consumption, and cost of the short-range radar device of the present invention are reduced, and thereby the objective of the present invention can be achieved.

In order to clarify the objectives, features, and advantages of the present invention and to enhance understanding, the following embodiments are described in detail, accompanied by the corresponding drawings.

### BRIEF DESCRIPTION OF THE DRAWINGS

FIG. 1A illustrates a circuit schematic diagram of a first embodiment of the short-range radar device of the present invention;

FIG. 1B illustrates a measurement diagram of a coupling strength between two transformers of the short-range radar device of the present invention;

FIG. 2A illustrates a circuit schematic diagram of a second embodiment of the short-range radar device of the present invention;

FIG. 2B illustrates a measurement diagram of the coupling strength between two transformers in the second embodiment of the short-range radar device of the present invention;

FIG. 3A illustrates a circuit schematic diagram of the short-range radar device according to a third embodiment of the present invention;

FIG. 3B illustrates an overall schematic diagram of the short-range radar device according to the third embodiment of the present invention;

FIG. 4A illustrates an overall schematic diagram of the short-range radar device according to a fourth embodiment of the present invention;

FIG. 4B illustrates an overall schematic diagram of the short-range radar device according to a fifth embodiment of the present invention;

FIG. 5 illustrates a circuit diagram of a conventional radar device; and

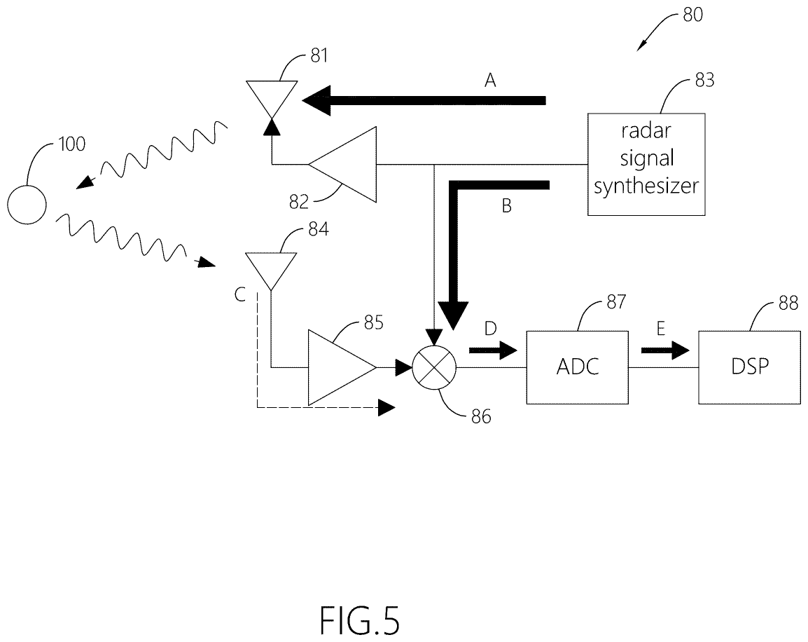

FIG. 6 illustrates a signal diagram of a conventional radar device.

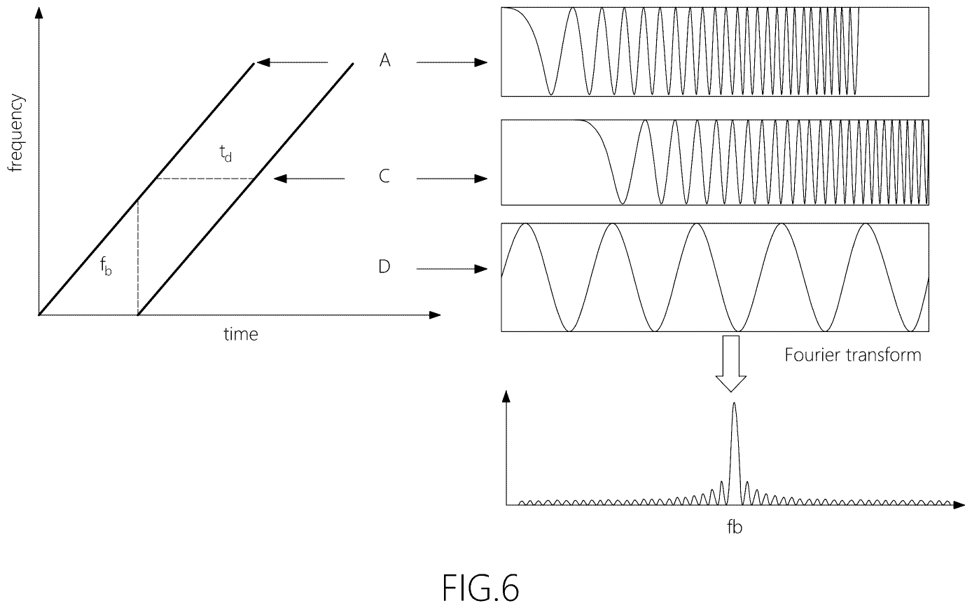

### DETAILED DESCRIPTION OF THE INVENTION

The technical contents, features and effects of the present invention will be clearly elucidated in the following detailed description of the preferred embodiment, accompanied by reference to the drawings. Additionally, the directional terms mentioned in the following embodiments, such as: up, down, left, right, front, back, bottom, top, etc. are only relative directions based on the drawings and do not denote absolute directional positions; therefore, the directional terms are used solely for illustrating their relative positional relationships and do not impose limitations on the present invention.

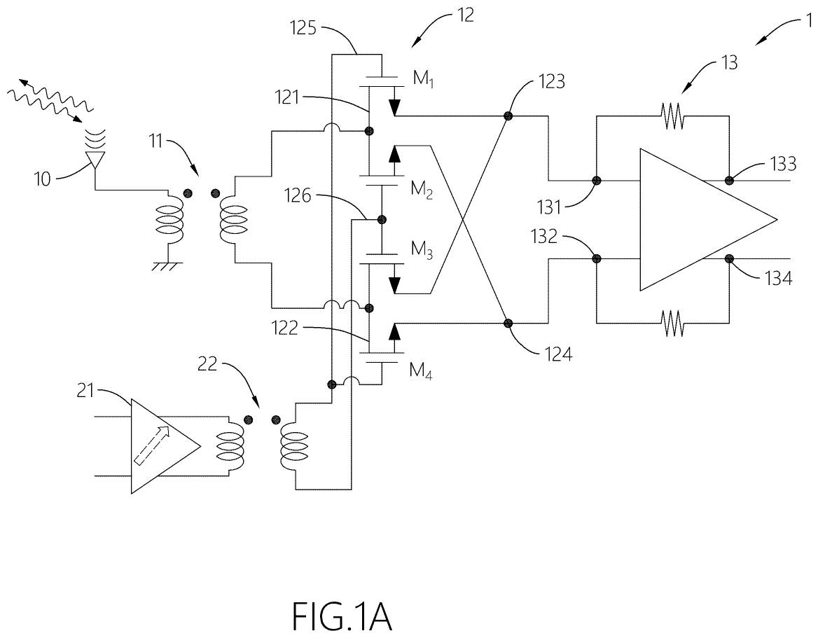

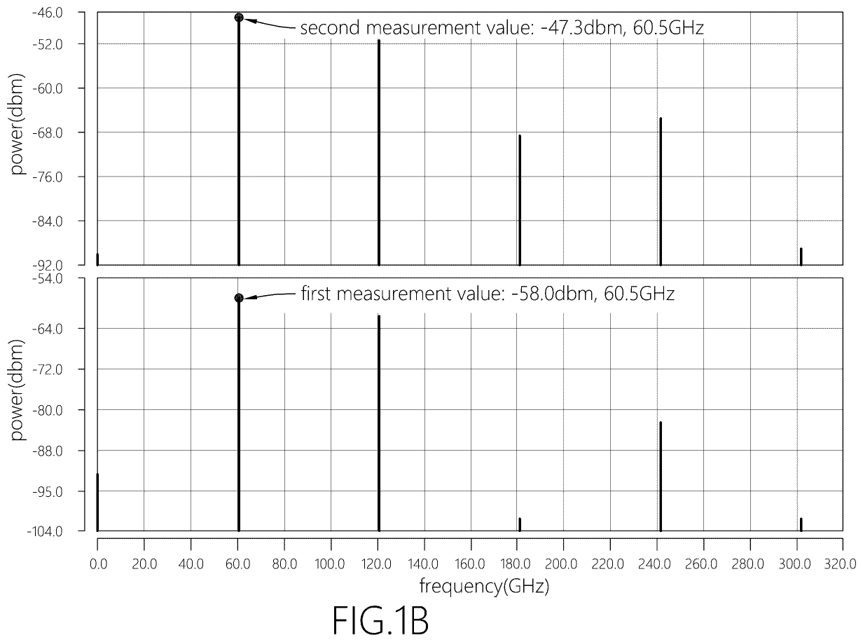

Please refer to FIG. 1A. FIG. 1A is a circuit schematic diagram of a first embodiment of the short-range radar device 1 of the present invention. The short-range radar device 1 of the present invention comprises a receiving antenna 10 with a signal end, and an input transformer 11 with a primary side and a secondary side. One end of the primary side of the input transformer 11 is connected to the signal end of the receiving antenna 10, and another end of the primary side of the input transformer 11 is a ground end, which is connected to ground voltage; the short-range radar device 1 of the present invention also comprises a tunable-local-oscillator amplifier 21 with a pair of input ends and a pair of output ends, and a local-oscillator transformer 22 with a primary side and a secondary side. Two ends of the primary side of the local-oscillator transformer 22 are connected with the pair of output ends of the tunable-local-oscillator amplifier 21, and the pair of input ends of the tunable-local-oscillator amplifier 21 are connected to a radar signal synthesizer (not shown) to receive a radar signal. The radar signal is, for example, a frequency-modulated-continuous wave (FMCW) radar signal.

The short-range radar device 1 of the present invention also comprises a mixer 12 having a first input end 121, a second input end 122, a first output end 123, a second output end 124, a first control end 125, and a second control end 126. The first input end 121 and the second input end 122 of the mixer 12 are respectively connected to both ends of the secondary side of the input transformer 11, and the first control end 125 and the second control end 126 of the mixer 12 are respectively connected to both ends of the secondary side of the local-oscillator transformer 22; the short-range radar device 1 of the present invention also comprises a transimpedance amplifier 13 having a first input end 131, a second input end 132, a first output end 133, and a second output end 134. The first input end 131 and the second input end 132 of the transimpedance amplifier 13 are respectively connected to the first output end 123 and the second output end 124 of the mixer 12. The first output end 133 and the second output end 134 of the transimpedance amplifier 13 are connected to an analog-to-digital converter (ADC, not shown) and then the analog-to-digital converter is connected to a digital signal processor (DSP, not shown). The first output end 133 and the second output end 134 of the transimpedance amplifier 13 output an intermediate-frequency signal to the analog-to-digital converter (not shown), the analog-to-digital converter (not shown) is used to output a digitized raw data to the digital signal processor (not shown), and the digital signal processor (not shown) is used to generate a feature map output, so that the relative distance and orientation information between the receiving antenna 10 and a target at a near distance can be obtained based on the feature map.

The mixer 12 is composed of a pair of a first transistor M1 and a second transistor M2 parallelly connected, and a pair of a third transistor M3 and a fourth transistor M4 parallelly connected. The gate of the first transistor M1 is connected to the gate of the fourth transistor M4, and the gate of the second transistor M2 is connected to the gate of the third transistor M3. It can be seen that the drain of the first transistor M1 is connected to the drain of the second transistor M2 to form the first input end 121 of the mixer 12. The source of the first transistor M1 is connected to the source of the third transistor M3 to form the first output end 123 of the mixer 12, the drain of the third transistor M3 and the drain of the fourth transistor M4 are connected to form the second input end 122 of the mixer 12, and the source of the third transistor M3 is connected to the source of the first transistor M1 to form the second output end 124 of the mixer 12. The gate of the first transistor M1 is connected to the gate of the fourth transistor M4 to form the first control end 125 of the mixer 12, and the gate of the second transistor M2 is connected to the gate of the third transistor M3 to form the second control end 126 of the mixer 12.

The tunable-local-oscillator amplifier 21 may control the output amplitude of the tunable-local-oscillator amplifier 21 either by having an output amplitude control end (not shown) to receive an output amplitude adjustment signal, or by directly altering the circuit of the tunable-local-oscillator amplifier 21.

In the first embodiment of the short-range radar device 1 of the present invention, when the local-oscillator transformer 22 transmits a control signal (i.e., a differential signal) to the first control end 125 and the second control end 126 of the mixer 12, the differential signal (i.e., the control signal) leaks to the receiving antenna 10 through the mixer 12 and the input transformer 11.

The main reasons for the leakage are physical size mismatches between the first transistor M1/the second transistor M2 and the third transistor M3/the fourth transistor M4 of the mixer 12, and/or signal coupling between the input transformer 11 and the local-oscillator transformer 22.

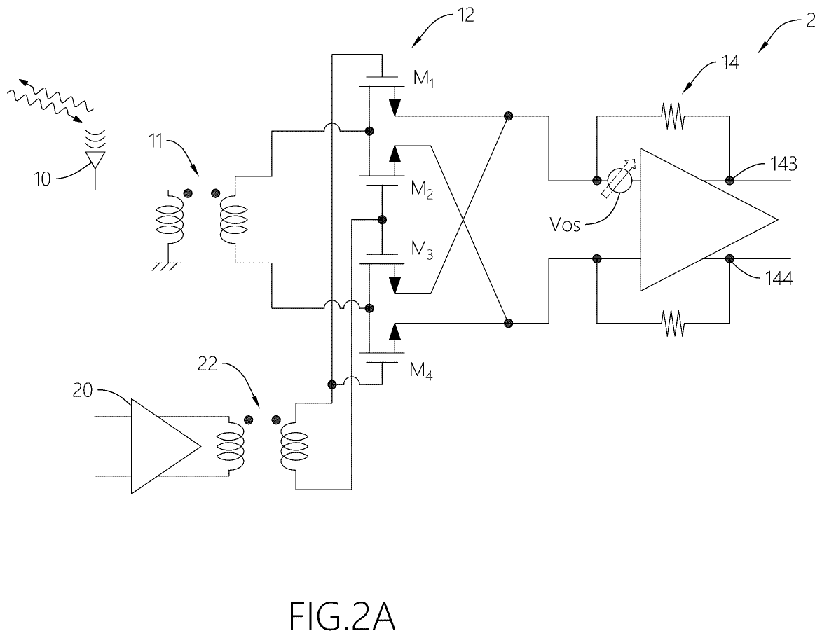

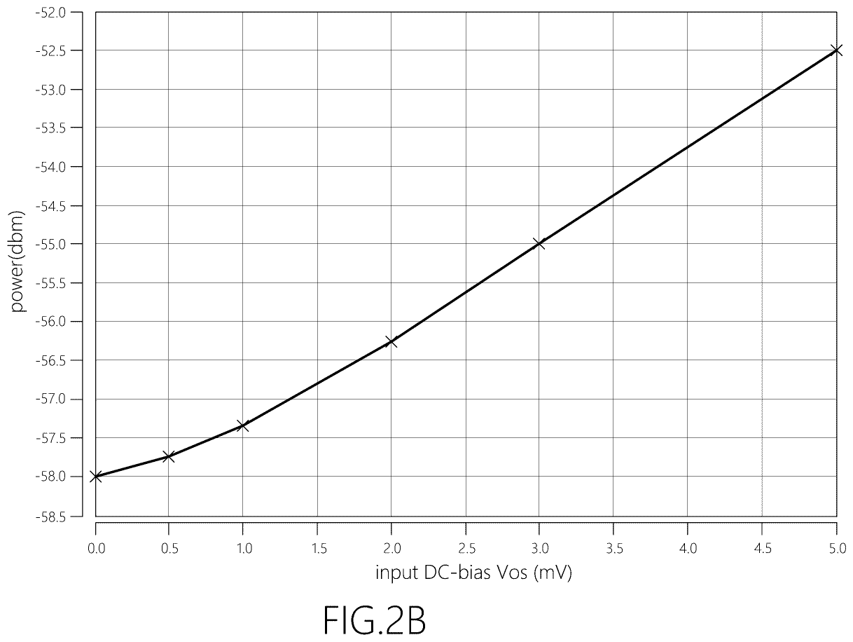

Please refer to FIG. 1B and FIG. 1A. FIG. 1B illustrates a measurement for the coupling strength between the two transformers (11, 22) of the short-range radar device 1 of the present invention. In FIG. 1B, a first measurement value “−58.0 dBm” is the measured signal power of the input transformer 11 when there is no coupling between the input transformer 11 and the local-oscillator transformer 22 (FIG. 1A, except that the local-oscillator transformer 22 is removed therein); a second measurement value “−47.0 dBm” is the measured signal power of the input transformer 11 when the input transformer 11 and the local-oscillator transformer 22 are coupled (FIG. 2A, where the local-oscillator transformer 22 is present therein), it can be seen that the differential signal from the local-oscillator transformer 22 directly contributes near 11 dBm to the measured signal power of the input transformer 11.

Based on FIG. 1B and above-mentioned, it can be known that when the output amplitude of the tunable-local-oscillator amplifier 21 is controlled to increase, direct contribution from the differential signal of the tunable-local-oscillator transformer 21 to the measured signal power of the input transformer 11 will also be increased accordingly (i.e., the portion of the differential signal from the tunable-local-oscillator transformer 21 leaking to the input transformer 11 is also increased accordingly). Therefore, when a target at a near distance is to be detected by the first embodiment of the short-range radar device 1 of the present invention, the portion of the differential signal from the tunable-local-oscillator transformer 21 leaking to the receiving antenna 10 can be used as a radar signal radiated by the short-range radar device 1 of the present invention for detecting targets at the near distances, and the intensity of the radar signal radiated by the short-range radar device 1 of the present invention can be adjusted by tuning the output amplitude of the differential signal from the tunable-local-oscillator amplifier 21. Accordingly, the radar signal can be kept in a controllable and stable state for stably detecting targets at near distances. Compared with ordinary radar devices, the first embodiment of the short-range radar device 1 of the present invention can optionally eliminate a dedicated transmitting antenna and its related amplifier circuits, etc., so that the size, power consumption, and cost of the short-range radar device 1 of the present invention are reduced, and the first embodiment of the short-range radar device 1 of the present invention is suitable for detecting targets at near distances and thereby the objective of the present invention can be achieved.

Please refer to FIG. 2A. FIG. 2A illustrates a circuit schematic diagram of a second embodiment of the short-range radar device 1 of the present invention. In the second embodiment of the short-range radar device 1 of the present invention, an adjustable-transimpedance amplifier 14 is used to substitute the transimpedance amplifier 13 in the first embodiment of the short-range radar device 1 of the present invention, and the tunable-local-oscillator amplifier 21 in the first embodiment of the short-range radar device 1 of the present invention is substituted by a local-oscillator amplifier 20 which does not have an amplitude adjustment function.

A magnitude of an input DC-bias Vos of the adjustable-transimpedance amplifier 14 can be adjusted either by having a DC-bias input control end (not shown) to receive a DC-bias input control signal, or by directly altering the circuit of the adjustable-transimpedance amplifier 14.

Please refer to FIG. 2B. FIG. 2B illustrates a measurement for the coupling strength between the two transformers (11, 22) in the second embodiment of the short-range radar device 1 of the present invention. In FIG. 2B of this embodiment, a measured signal power of the input transformer 11 is “−58 dBm” when the input DC-bias Vos of the adjustable-transimpedance amplifier 14 is 0V; and a measured signal power of the input transformer 11 is “−52.5 dBm” when the input DC-bias Vos of the adjustable-transimpedance amplifier 14 is 5 mV. It can be seen that for every 5 mV increase in the input DC-bias Vos of the adjustable-transimpedance amplifier 14, the measured signal power of the input transformer 11 is increased by “5.5 dB”. It can be seen that an increase in the input DC-bias Vos of the adjustable-transimpedance amplifier 14 will cause the coupling strength between the two transformers (11, 22) to increase accordingly (that is, the portion of the differential signal leaking from the local-oscillator transformer 22 to the input transformer 11 is increased accordingly).

Based on FIG. 2B, in the second embodiment of the short-range radar device 1 of the present invention, the portion of the differential signal from the local-oscillator transformer 22 leaking to the receiving antenna 10 can be used as a radar signal emitted by the short-range radar device 1 of the present invention to detect a target at a near distance, and the intensity of the radar signal radiated by the short-range radar device 1 of the present invention can be controlled through the input DC-bias Vos. As a result, the radar signal can be maintained in a controllable and stable state for stably detecting targets at near distances. Compared with ordinary radar devices, the second embodiment of the short-range radar device 1 of the present invention can optionally eliminate a dedicated transmitting antenna and its related amplifier circuits, etc., so that the size, power consumption, and cost of the short-range radar device 1 of the present invention are reduced, and the second embodiment of the short-range radar device 1 of the present invention is suitable for detecting targets at near distances and thereby the objective of the present invention can be achieved.

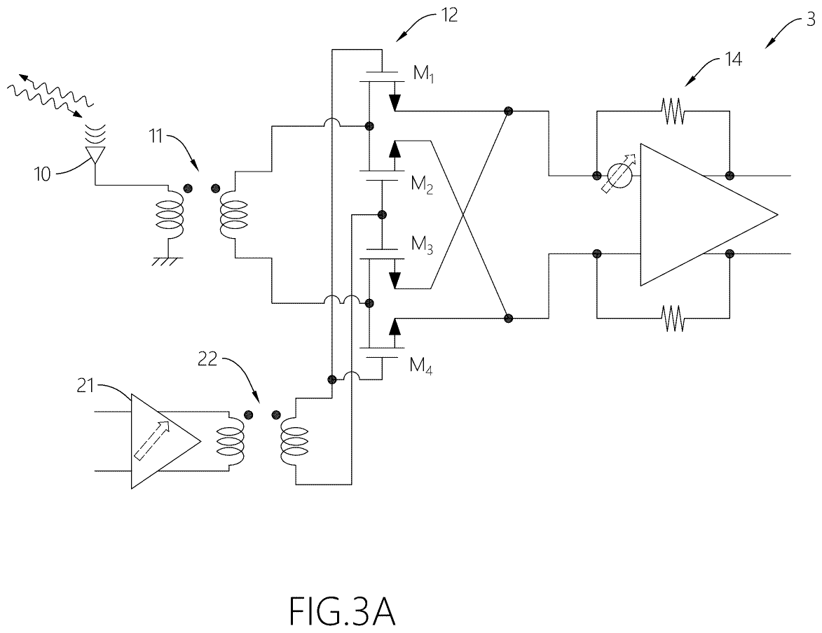

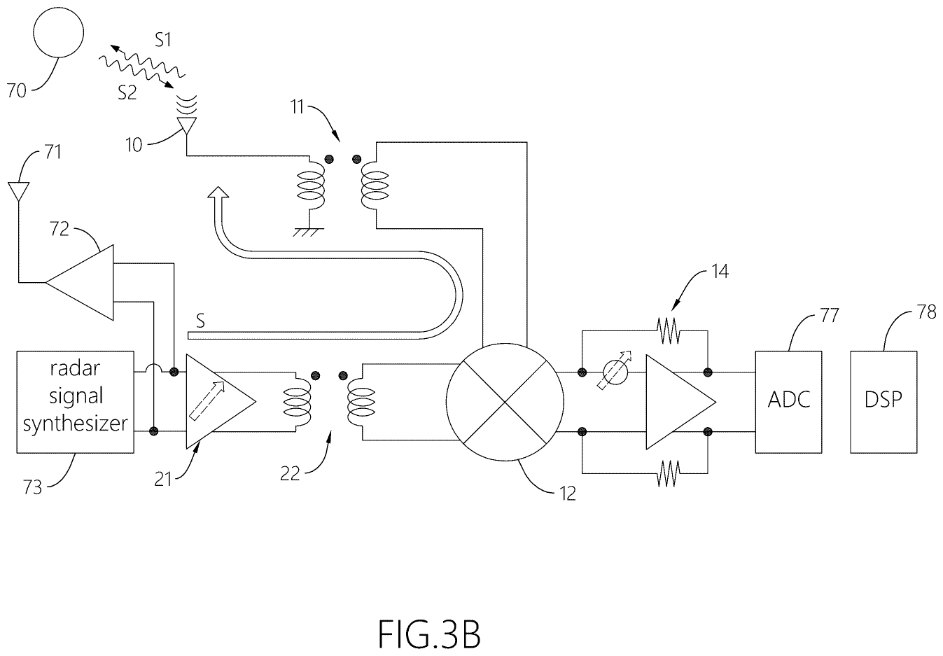

Please refer to FIG. 3A. FIG. 3A illustrates a circuit schematic diagram of a third embodiment of the short-range radar device 1 of the present invention. In the third embodiment of the short-range radar device 1 of the present invention, the short-range radar device 1 of the present invention comprises the same tunable-local-oscillator amplifier 21 of the first embodiment and the same adjustable-transimpedance amplifier 14 of the second embodiment; and the rest of the circuits in the third embodiment of the short-range radar device 1 of the present invention are the same as those in the first and the second embodiments. In the third embodiment of the short-range radar device 1 of the present invention, the portion of the differential signal of the adjustable local-oscillator transformer 21 leaking to the receiving antenna 10 can be used as a radar signal radiated by the short-range radar device 1 of the present invention to detect a target at a near distance. Moreover, in the third embodiment of the short-range radar device 1 of the present invention, the output amplitude of the tunable-local-oscillator amplifier 21 and/or the magnitude of the input DC-bias Vos of the adjustable-transimpedance amplifier 14 can be controlled to optimally maintain the radar signal in a controllable and stable state for the short-range radar device 1 to stably detect targets at near distances. Compared with ordinary radar devices, the third embodiment of the short-range radar device 1 of the present invention can optionally eliminate a dedicated transmitting antenna and its related amplifier circuit, etc., so that the size, power consumption, and cost of the third embodiment of the short-range radar device 1 of the present invention are reduced, and the third embodiment of the short-range radar device 1 of the present invention is suitable for detecting targets at near distances and thereby the objective of the present invention can be achieved.

Please refer to FIG. 3B. FIG. 3B illustrates an overall schematic diagram of the third embodiment of the short-range radar device 1 of the present invention. In addition to the components illustrated in FIG. 3A, FIG. 3B further illustrates an output antenna 71, an output power amplifier 72, a radar signal synthesizer 73, an analog-to-digital converter 77, and a digital signal processor 78, wherein the existence or operation of the output antenna 71 and the output power amplifier 72 will not affect the above-mentioned functions of the present invention, that is to say, regardless of presence or absence of the output antenna 71 and the output power amplifier 72, and regardless of operation or non-operation of the output antenna 71 and the output power amplifier 72, the output antenna 71 and the output power amplifier 72 will not affect the functions of the receiving antenna 10 and associated circuits of the present invention to transmit a radar signal S1 and receive a reflected wave signal S2 of the radar signal S1 for detecting a target 70 at a relatively near distance, nor will the output antenna 71 and the output power amplifier 72 affect the functions of the receiving antenna 10 and the associated circuits of the present invention to receive a general input signal. Wherein the radar signal synthesizer 73 outputs a radar signal S to both the output power amplifier 72 and the tunable-local-oscillator amplifier 21. The output power amplifier 72 amplifies the radar signal S and outputs it to the output antenna 71 to radiate a radar signal (i.e., the output antenna 71 and the output power amplifier 72 are present and operating), and the radar signal S is also amplified and output to the local-oscillator transformer 22 through the tunable-local-oscillator amplifier 21, and then input to the receiving antenna 10 through the mixer 12 and the input transformer 11 to generate and radiate the radar signal S1. At the same time, a general input signal (not shown) received by the receiving antenna 10 is output to the analog-to-digital converter (ADC) 77 via the input transformer 11, the mixer 12, and the adjustable-transimpedance amplifier 14, and then the analog-to-digital converter 77 outputs a converted digital signal of the general input signal (not shown) to the digital signal processor (DSP) 78. As for the remaining technical details, please refer to the relevant contents of FIG. 1A to FIG. 3A aforementioned. In one embodiment, the tunable-local-oscillator amplifier 21 in FIG. 3B can be substituted by the local-oscillator amplifier 20. In another embodiment, the adjustable-transimpedance amplifier 14 in FIG. 3B can be substituted by the transimpedance amplifier 13.

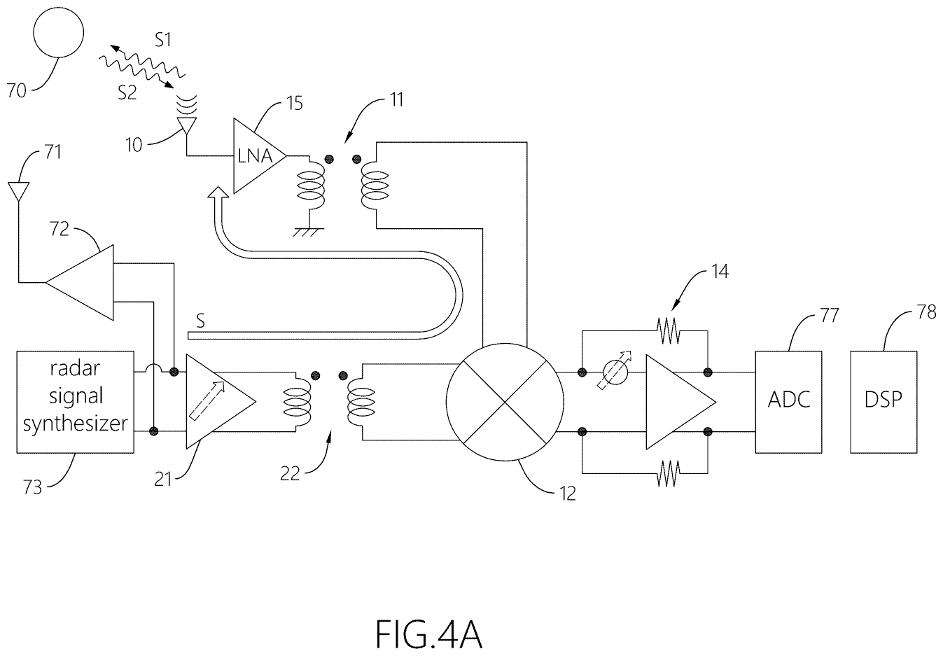

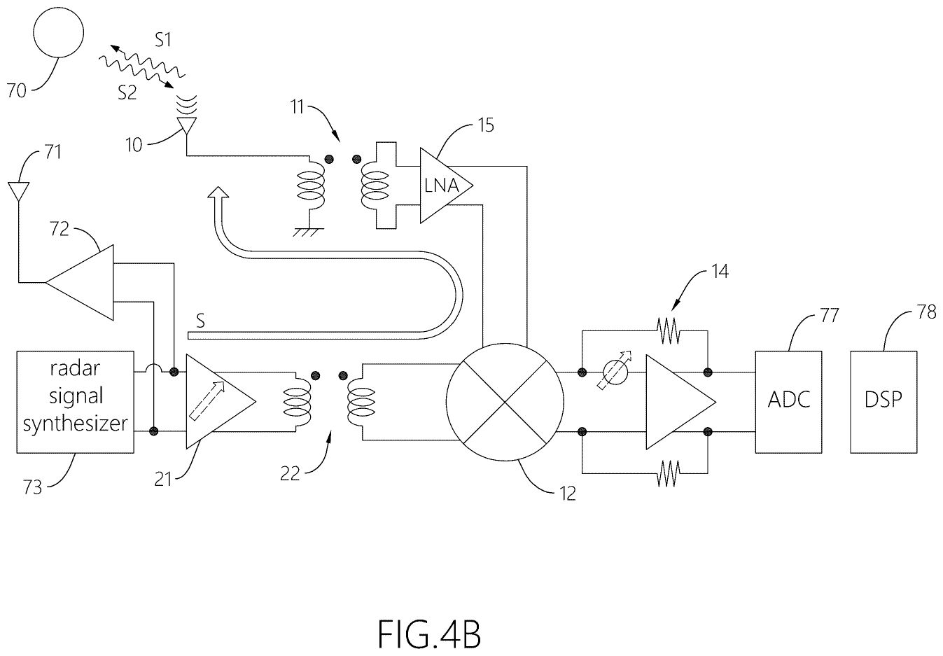

Please refer to FIG. 4A. FIG. 4A illustrates an overall schematic diagram of a fourth embodiment of the short-range radar device 1 of the present invention. In addition to the components illustrated in FIG. 3B, FIG. 4A further illustrated a low-noise amplifier (LNA) 15. The low-noise amplifier 15 is used to receive a signal from the receiving antenna 10 and amplify it before outputting it to the input transformer 11. A cascode stage of the low-noise amplifier 15 can be removed to reduce signal isolation between an input end and an output end of the low-noise amplifier 15. A capacitive coupling path can also be deliberately added between the input end and the output end of the low-noise amplifier 15 to reduce the signal isolation between the input end and the output end of the low-noise amplifier 15. In one embodiment, the tunable-local-oscillator amplifier 21 in FIG. 4A can be substituted by the local-oscillator amplifier 20; in another embodiment, the adjustable-transimpedance amplifier 14 in FIG. 4A can be substituted by the transimpedance amplifier 13.

Please refer to FIG. 4B. FIG. 4B illustrates an overall schematic diagram of a fifth embodiment of the short-range radar device 1 of the present invention. The components illustrated in FIG. 4B are the same as those in FIG. 4A. The difference between FIG. 4B and FIG. 4A lies only in the location of the low-noise amplifier (LNA) 15, and the rest of the technical characteristics are the same, that is, in FIG. 4B, the low-noise amplifier 15 is positioned between the input transformer 11 and the mixer 12. In one embodiment, the tunable-local-oscillator amplifier 21 in FIG. 4B can be replaced by the local-oscillator amplifier 20; in another embodiment, the adjustable-transimpedance amplifier 14 in FIG. 4B can be replaced by the transimpedance amplifier 13.

While the present invention has been described above in a preferred embodiment, it is not intended to limit the invention. Those skilled in the art may make changes and modifications without departing from the spirit and scope of the invention. Therefore, the scope of protection of the invention shall be determined by the appended patent claims.

What is claimed is:

1. A short-range radar device, comprising:
a receiving antenna with a signal end;
an input transformer having a primary side and a secondary side, one end of the primary side of the input transformer connected to the signal end of the receiving antenna, and another end of the primary side of the input transformer being a ground end;
a tunable-local-oscillator amplifier having a pair of input ends and a pair of output ends, the pair of input ends of the tunable-local-oscillator amplifier configured to receive a radar signal;
a local-oscillator transformer having a primary side and a secondary side, and both ends of the primary side of the local-oscillator transformer respectively connected to the pair of output ends of the tunable-local-oscillator amplifier;
a mixer having a first input end, a second input end, a first output end, a second output end, a first control end, and a second control end; the first input end and the second input end of the mixer respectively connected to both ends of the secondary side of the input transformer, and the first control end and the second control end of the mixer respectively connected to both ends of the secondary side of the local-oscillator transformer; and
a transimpedance amplifier having a first input end, a second input end, a first output end, and a second output end; the first input end and the second input end of the transimpedance amplifier respectively connected to the mixer, the first output end and the second output end of the transimpedance amplifier configured to jointly output an intermediate-frequency signal.

2. The short-range radar device as claimed in claim 1, wherein
the pair of input ends of the tunable-local-oscillator amplifier is connected to a radar signal synthesizer; and
the first output end and the second output end of the transimpedance amplifier are connected to an analog-to-digital converter.

3. The short-range radar device as claimed in claim 1, wherein the ground end of the input transformer is connected to a ground voltage.

4. The short-range radar device as claimed in claim 2, wherein the analog-to-digital converter is further connected to a digital signal processor.

5. The short-range radar device as claimed in claim 4, wherein the analog-to-digital converter receives the intermediate-frequency signal and converts the intermediate-frequency signal into a digitized raw data; the digital signal processor receives the digitized raw data and converts the digitized raw data to a feature map.

6. The short-range radar device as claimed in claim 1, wherein a low-noise amplifier is further provided between the receiving antenna and the input transformer, so that the receiving antenna and the input transformer are no longer directly connected, wherein
the low-noise amplifier has an output end and an input end, the input end of the low-noise amplifier is connected to the signal end of the receiving antenna, and the output end of the low-noise amplifier is connected to the end of the primary side of the input transformer.

7. The short-range radar device as claimed in claim 6, wherein the low-noise amplifier does not have a cascode stage.

8. The short-range radar device as claimed in claim 6, further including a capacitively coupled path that reduces signal isolation between the output end and the input end of the low-noise amplifier.

9. The short-range radar device as claimed in claim 1, wherein
a low-noise amplifier is further provided between the input transformer and the mixer, so that the input transformer and the mixer are no longer directly connected, wherein
the low-noise amplifier has a pair of output ends and a pair of input ends, the pair of input ends of the low-noise amplifier are respectively connected to two ends of the secondary side of the input transformer, and the pair of output ends of the low-noise amplifier are respectively connected to the first input end and the second input end of the mixer.

10. The short-range radar device as claimed in claim 9, wherein the low-noise amplifier does not have a cascode stage.

11. The short-range radar device as claimed in claim 9, further including a capacitively coupled path that reduces signal isolation between the output end and the input end of the low-noise amplifier.

12. A short-range radar device, comprising:
a receiving antenna with a signal end;
an input transformer having a primary side and a secondary side, one end of the primary side of the input transformer connected to the signal end of the receiving antenna, and another end of the primary side of the input transformer being a ground end;
a local-oscillator amplifier having a pair of input ends and a pair of output ends, the pair of input ends of the local-oscillator amplifier configured to receive a radar signal;
a local-oscillator transformer having a primary side and a secondary side, and both ends of the primary side of the local-oscillator transformer connected to the pair of output ends of the local-oscillator amplifier respectively;
a mixer having a first input end, a second input end, a first output end, a second output end, a first control end, and a second control end; the first input end and the second input end of the mixer respectively connected to both ends of the secondary side of the input transformer, and the first control end and the second control end of the mixer respectively connected to both ends of the secondary side of the local-oscillator transformer; and
an adjustable-transimpedance amplifier having a first input end, a second input end, a first output end, and a second output end; the first input end and the second input end of the adjustable-transimpedance amplifier respectively connected to the first output end and the second output end of the mixer, the first output end and the second output end of the adjustable-transimpedance amplifier jointly configured to output an intermediate-frequency signal.

13. The short-range radar device as claimed in claim 12, wherein
the pair of input ends of the local-oscillator amplifier are connected to a radar signal synthesizer; and
the first output end and the second output end of the adjustable-transimpedance amplifier are connected to an analog-to-digital converter.

14. The short-range radar device as claimed in claim 12, wherein a low-noise amplifier is further provided between the receiving antenna and the input transformer, so that the receiving antenna and the input transformer are no longer directly connected, wherein
the low-noise amplifier has an output end and an input end, the input end of the low-noise amplifier is connected to the signal end of the receiving antenna, and the output end of the low-noise amplifier is connected to the end of the primary side of the input transformer.

15. The short-range radar device as claimed in claim 12, wherein
a low-noise amplifier is further provided between the input transformer and the mixer, so that the input transformer and the mixer are no longer directly connected, wherein
the low-noise amplifier has a pair of output ends and a pair of input ends, the pair of input ends of the low-noise amplifier are respectively connected to two ends of the secondary side of the input transformer, and the pair of output ends of the low-noise amplifier are respectively connected to the first input end and the second input end of the mixer.

16. A short-range radar device, comprising:
a receiving antenna with a signal end;
an input transformer having a primary side and a secondary side, one end of the primary side of the input transformer connected to the signal end of the receiving antenna, and another end of the primary side of the input transformer being a ground end;
a tunable-local-oscillator amplifier having a pair of input ends and a pair of output ends, the pair of input ends of the tunable-local-oscillator amplifier receiving a radar signal;
a local-oscillator transformer having a primary side and a secondary side, and both ends of the primary side of the local-oscillator transformer connected to the pair of output ends of the tunable-local-oscillator amplifier respectively;
a mixer having a first input end, a second input end, a first output end, a second output end, a first control end, and a second control end; the first input end and the second input end of the mixer respectively connected to both ends of the secondary side of the input transformer, and the first control end and the second control end of the mixer respectively connected to both ends of the secondary side of the local-oscillator transformer; and
an adjustable-transimpedance amplifier having a first input end, a second input end, a first output end, and a second output end; the first input end and the second input end of the adjustable-transimpedance amplifier respectively connected to the mixer; the first output end and the second output end of the adjustable-transimpedance amplifier configured to jointly output an intermediate-frequency signal.

17. The short-range radar device as claimed in claim 16, wherein the pair of input ends of the tunable-local-oscillator amplifier is connected to a radar signal synthesizer; and
the first output end and the second output end of the adjustable-transimpedance amplifier are connected to an analog-to-digital converter.

18. The short-range radar device as claimed in claim 16, wherein a low-noise amplifier is further provided between the receiving antenna and the input transformer, so that the receiving antenna and the input transformer are no longer directly connected, wherein
the low-noise amplifier has an output end and an input end, the input end of the low-noise amplifier is connected to the signal end of the receiving antenna, and the output end of the low-noise amplifier is connected to the end of the primary side of the input transformer.

19. The short-range radar device as claimed in claim 16, wherein
a low-noise amplifier is further provided between the input transformer and the mixer, so that the input transformer and the mixer are no longer directly connected, wherein
the low-noise amplifier has a pair of output ends and a pair of input ends, the pair of input ends of the low-noise amplifier are respectively connected to two ends of the secondary side of the input transformer, and the pair of output ends of the low-noise amplifier are respectively connected to the first input end and the second input end of the mixer.
